(19) United States
(12) Patent Application Publication
(10) Pub. No.: US 2006/0033887 A1
(43) Pub. Date: Feb. 16, 2006

(54) IMAGE PROJECTION DEVICE

(76) Inventor: Sze-Ke Wang, Miao-Li County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,576

(22) Filed: Nov. 17, 2004

(30) Foreign Application Priority Data
Aug. 10, 2004 (TW) 93123881

(51) Int. Cl. G03B 21/00

(52) U.S. Cl. 353/46

(57) ABSTRACT

An image projection device comprising a light source, a projection lens, an imaging unit, an image displacement element, an optical path compensator and a control unit is provided. When a light beam from a light source passes through the imaging unit, the imaging unit converts the light beam into a plurality of sub-images. Thereafter, the sub-images pass through the image displacement element and the optical path compensator and project the sub-images onto a screen through the projection lens. The image displacement element switches the positions of the sub-images projected on the screen. Furthermore, the control unit synchronizes the sub-images into an integral image. In addition, a moveable projection lens or a moveable imager inside the imaging unit can replace the image displacement element.

### CROSS-REFERENCE TO RELATED APPLICATION

This application claims the priority benefit of Taiwan application serial no. 93123881, filed Aug. 10, 2004.

### BACKGROUND OF THE INVENTION

1. Field of the Invention

The present invention relates to an image projection device. More particularly, the present invention relates to an image projection device capable of projecting a high-resolution image using a low-resolution display device so that overall production cost is reduced.

2. Description of the Related Art

In recent years, liquid crystal displays have found a broad spectrum of applications in many electrical appliances including direct-viewing displays and indirect-viewing display panels for liquid crystal projectors and rear projection televisions. Examples of the direct viewing displays include liquid crystal monitors, notebook computers and digital liquid crystal televisions and examples of the indirect viewing display panels include liquid crystal on silicon (LCOS) panels, high-temperature polysilicon liquid crystal displays (HTPS-LCD) and digital micro-mirror devices (DMD). Because direct-viewing displays have definite dimensional limitations, the integration of a high-resolution indirect viewing display panel with an efficient optical engine has become the mainstream design for producing a large rear projector and rear projection television.

Most rear projection display products deploy an optical engine to generate and project an image onto a screen. To ensure a high-resolution projected image on the screen, the optical engine must deploy a high-resolution display device.

FIG. 1 is a schematic diagram showing various major components inside a conventional image projection device. As shown in FIG. 1, the image projection device 100 mainly comprises a light source 110, a projection lens 120, an imaging unit 130 and a control unit 160. The light source 110 provides a beam of white light 112. The projection lens 120 is disposed somewhere along the path of the white beam 112. The imaging unit 130 is disposed between the light source 110 and the projection lens 120. The imaging unit 130 comprises a color wheel 132, a light integration rod 134, a group of condenser 136, a total internal reflection (TIR) prism 138 and a display device 139. The control unit 160 is a circuit board comprising an image processor 162 electrically connected to the color wheel 132 and the display unit 139 for synchronizing the production of images.

In the aforementioned projection device 100, the white beam 112 from the light source 110 passes through the color wheel 132 controlled by the control unit 160. Through a combination of the red, green and blue color filters in the color wheel 132, the white light 112 is split in sequence into red, green and blue monochromatic light beams 114. These monochromatic light beams 114 sequentially pass through the light integration rod 134 and the condenser 136 before entering the TIR prism 138. The TIR prism 138 reflects the monochromatic light beams 114 in sequence to the display device 139. Thereafter, the image processor 162 inside the control unit 160 controls the display device 139 to convert the monochromatic light beams 114 into monochromatic images (not shown) in sequence. After that, the monochromatic images are sequentially transmitted to the TIR prism 138 and then project onto a screen (not shown) through the projection lens 120 to form a full color image.

In conventional projection device 100, to produce an image with higher resolution, a high-resolution display device 139 must be used. However, a high-resolution display device 139 is expensive to produce. Hence, overall cost of producing the projection device is increased.

### SUMMARY OF THE INVENTION

Accordingly, the present invention is directed to provide an image projection device that uses an image displacement element together with a lower-resolution display device to project a high-resolution image and reduce overall production cost.

The present invention is directed to provide an image projection device that uses a moveable projection lens together with a lower-resolution display device to project a high-resolution image and reduce overall production cost.

The present invention is directed to provide an image projection device that uses a moveable display device together with a lower-resolution display device to project a high-resolution image and reduce overall production cost.

As embodied and broadly described herein, the invention provides an image projection device. The image projection device mainly comprises a light source, a projection lens, an imaging unit, an image displacement element, an optical path compensator and a control unit. The light source provides a light beam and the projection lens is disposed somewhere along the path of the light beam. The imaging unit is disposed between the light source and the projection lens. The imaging unit is designed to convert the light beam into a plurality of sub-images within each frame. The image displacement element is disposed somewhere along the transmission path of the sub-images, for example, between the imaging unit and the projection lens or within the projection lens. The image displacement element is designed to switch the positions of the sub-images after passing through the projection lens. The image displacement element comprises a transparent plate or a reflective plate, for example. The optical path compensator has a rectangular shape for interposing into the transmission path of the sub-images, such as the area between the imaging unit and the projection lens or the interior of the projection lens, within a specified time and compensating for any optical path difference. The control unit controls the imaging unit and the image displacement element so that the sub-images are synchronized to form an image with a resolution higher than each sub-image. The control unit further comprises an image processor, an image displacement element controller and an optical path compensator controller, for example. The image processor controls the sub-images displayed by the imaging unit. The image displacement element controller is electrically connected to the image processor for controlling the movement of the image displacement element. Similarly, the optical path compensator is electrically connected to the image processor for controlling the movement of the optical path compensator.

The present invention provides another image projection device. The image projection device mainly comprises a light source, a moveable projection lens, an imaging unit, an optical path compensator and a control unit. The light source provides a light beam and the moveable projection lens is disposed somewhere along the path of the light beam. The imaging unit is disposed between the light source and the moveable projection lens. The imaging unit is designed to convert the light beam into a plurality of sub-images within each frame and the moveable projection lens is designed to switch the imaging positions of the sub-images. The optical path compensator has a wedge shape for interposing into the transmission path of the sub-images, such as the area between the imaging unit and the moveable projection lens or the interior of the moveable projection lens, within a specified time and compensating for any optical path difference. The control unit controls the imaging unit and the moveable projection device so that the sub-images are synchronized to form an image with a resolution higher than each sub-image. The control unit further comprises an image processor, a moveable projection lens controller and an optical path compensator controller, for example. The image processor controls the sub-images displayed by the imaging unit. The moveable projection lens controller is electrically connected to the image processor for controlling the movement of the moveable projection device. Similarly, the optical path compensator is electrically connected to the image processor for controlling the movement of the optical path compensator.

The present invention provides yet another image projection device. The image projection device mainly comprises a light source, a projection lens, an imaging unit, an optical path compensator and a control unit. The light source provides a light beam and the projection lens is disposed somewhere along the path of the light beam. The imaging unit is disposed between the light source and the projection lens. The imaging unit has a moveable display device designed to convert the light beam into a plurality of sub-images within each frame and switch the imaging positions of the sub-images. The optical path compensator has a wedge shape for interposing into the transmission path of the sub-images, such as the area between the imaging unit and the projection lens or the interior of the projection lens, within a specified time and compensating for any optical path difference. The control unit controls the imaging unit and the moveable display device so that the sub-images are synchronized to form an image with a resolution higher than each sub-image. The control unit further comprises an image processor, a moveable display device controller and an optical path compensator controller, for example. The image processor controls the sub-images displayed by the moveable display device. The moveable display device controller is electrically connected to the image processor for controlling the movement of the moveable display device. Similarly, the optical path compensator is electrically connected to the image processor for controlling the movement of the optical path compensator.

In the aforementioned image projection devices, the imaging unit includes a liquid crystal display (LCD) panel, digital light processing (DLP) panel or a reflective liquid crystal on silicon (LCOS) panel, for example. In addition, the imaging unit may comprise a display device capable of rotating a definite angle such as 90° so that the projected image changes from a M×N resolution to N×M resolution where M>N.

The image projection device of the present invention deploys a control unit to oversee the conversion of the light beam into a plurality of sub-images within each frame by the imaging unit. In addition, an image displacement element, a moveable projection lens or a moveable display device is used to switch the imaging positions of these sub-images and synchronize these sub-images to form an image. Therefore, the image projection device can use a display device with a lower resolution to project an image with a higher resolution. Because a high-resolution display device cost more than a low-resolution display device, the production cost of the image projection device of the present invention is reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing various major components inside a conventional image projection device.

FIGS. 2A and 2B are schematic diagrams showing various components of an image projection device according to a first embodiment of the present invention.

FIG. 3 is a schematic diagram showing various components of an image projection device according to a second embodiment of the present invention.

FIG. 4 is a schematic diagram showing various components of an image projection device according to a third embodiment of the present invention.

FIG. 5 shows an image displacement in a projection device according to the present invention.

FIGS. 6A and 6B are diagrams showing the image-forming process of a projection device according to the present invention.

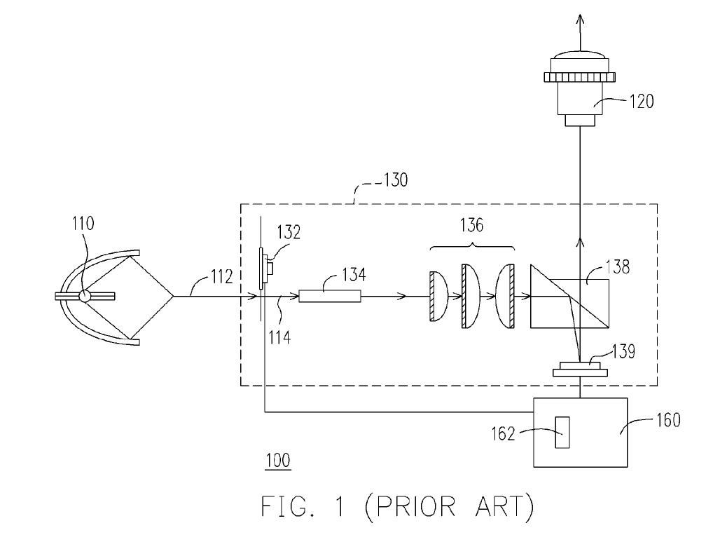

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

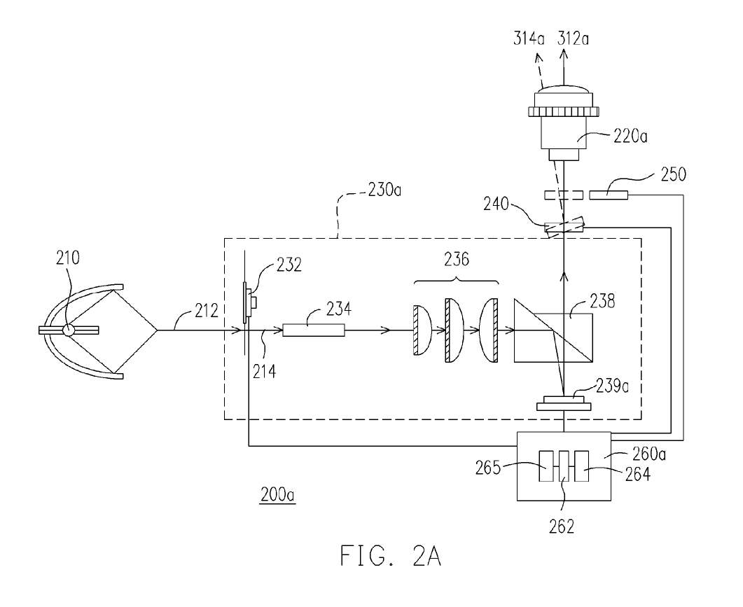

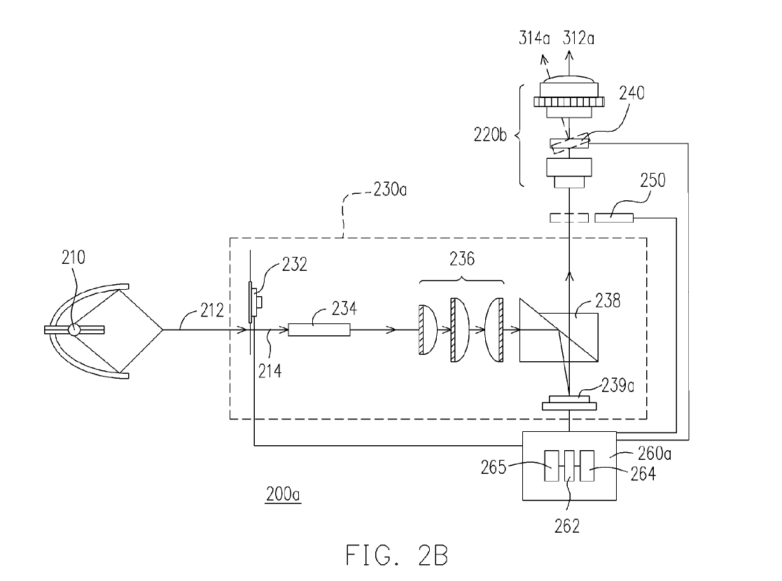

FIG. 2A is schematic diagram showing various components of an image projection device according to a first embodiment of the present invention. As shown in FIG. 2A, the present embodiment provides an image projection device 200a. The image projection device 200a mainly comprises a light source 210, a projection lens 220a, an imaging unit 230a, a image displacement element 240, an optical path compensator 250 and a control unit 260a. The light source 210 provides a beam of white light 212 and the projection lens 220a is disposed somewhere along the path of the light beam 212. The imaging unit 230a is disposed between the light source 210 and the projection lens 220a. The imaging unit 230a is designed to convert the beam of white light 212 into a plurality of sub-images within each frame. The imaging unit 230a can be a liquid crystal display (LCD) imaging unit, a digital light processing (DLP) imaging unit or a reflective liquid crystal on silicon (LCOS) display unit, for example. Using a digital light processing (DLP) imaging unit as an example, the imaging unit 230a comprises a color wheel 232, a light integration rod 234, a condenser 236, a total internal reflection (TIR) prism 238 and a display device 239a. The control unit 260a is, for example, a circuit board comprising an image processor 262, an image displacement element controller 264 and an optical path compensator controller 265. In the present embodiment, the control unit 260a is electrically connected to the color wheel 232 and the display unit 239a for controlling the production of images.

In the aforementioned projection device 200a, the white beam 212 from the light source 210 passes through the color wheel 232 controlled by the control unit 260a. The color wheel 232 comprises a combination of color filters for red, green and blue light, for example. Through the red, green and blue color filters in the color wheel 232, the white light 212 is split in sequence into red, green and blue monochromatic light beams 214. These monochromatic light beams 214 sequentially pass through the light integration rod 234 and the condenser 236 before entering the TIR prism 238. The TIR prism 238 reflects the sequentially input monochromatic light beams 214 to the display device 239a. Thereafter, the image processor 262 inside the control unit 260a controls the display device 239a to convert the monochromatic light beams 214 into monochromatic images (not shown) in sequence.

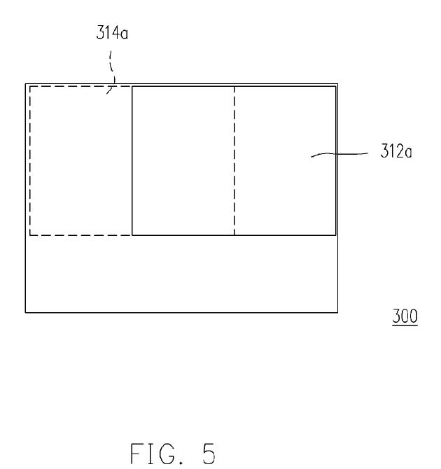

FIG. 5 shows an image displacement in a projection device according to the present invention. As shown in FIGS. 2A and 5, after sequentially converting the monochromatic light beams 214 into a plurality of sub-images through the display device 239a, the light beams 214 is returned to the TIR prism 238 before passing through the image displacement element 240. The image displacement element 240 is, for example, a transparent plate or a reflective plate (the image displacement element 240 in FIG. 2A is a transparent plate) capable of shifting the position of the sub-images up to a maximum distance of several tens of pixels. It should be noted that the movement of the of the image displacement element 240 is controlled by an image displacement element controller 264 inside the control unit 260a. The image displacement element controller 264 is electrically connected to the image processor 262 for switching the imaging positions of the sub-images after passing through the projection lens 220a. The sub-images not shifted by the image displacement element 240 are projected onto a first sub-regional block 312a of the screen 300 while the sub-images shifted by the image displacement element 240 are projected onto other areas of the screen 300 such as a second sub-regional block 314a of the screen 300.

After passing through the image displacement element 240, the sub-images not shifted by the image displacement element 240 are directly transmitted to the projection lens 220a. Meanwhile, the sub-images shifted by the image displacement element 240 have to pass through the optical path compensator 250 before transmitting to the projection lens 220a. The optical path compensator 250 has a rectangular shape capable of interposing into the transmission path of the sub-images at a prescribed time interval to compensate for any optical path difference. In other words, the optical path compensator 250 is set at a location away from the transmission path of the sub-images. However, the optical path compensator controller 265 can control the optical path compensator to interpose into the transmission path of the shifted sub-images within a prescribed time interval and improve any optical path difference. The optical path compensator controller 265 is electrically connected to the image processor 262. Furthermore, the optical path compensator 250 is designed to interpose into the transmission path of the sub-images between the imaging unit 230a and the projection lens 220a within a prescribed time interval or interpose into the interior of the projection lens 220a with a prescribed time interval. In addition, the interposition location of the optical path compensator 250 in the prescribed time interval can be anywhere before or after the image displacement element 264.

Thereafter, the sub-images are projected onto the screen 300 via the projection lens 220a. The control unit 260a controls the imaging unit 230a and the image displacement element 240 so that the sub-images are synchronized to form an image. It should be noted that the resolution of the image is higher than each sub-image.

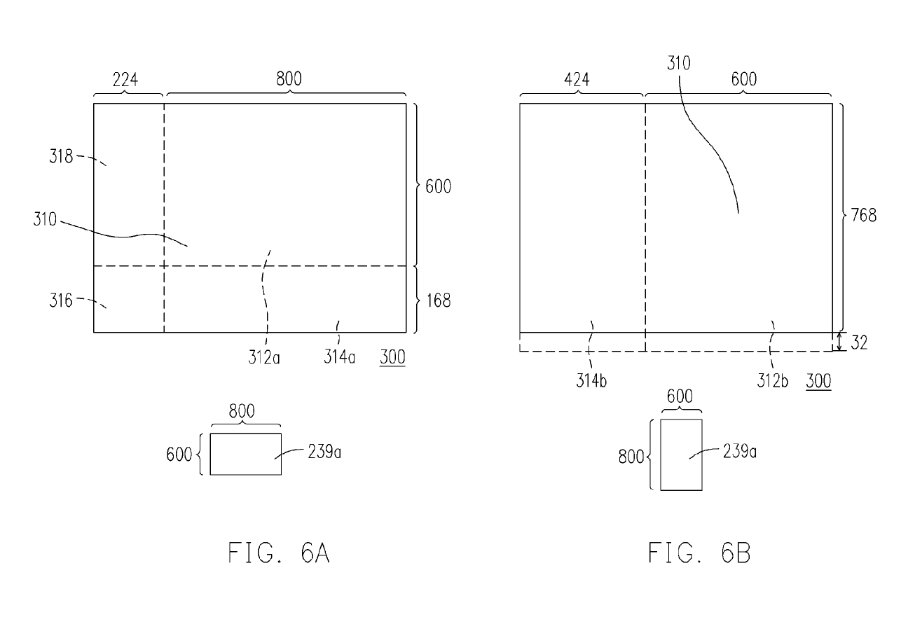

FIGS. 6A and 6B are diagrams showing the image-forming process of a projection device according to the present invention. As shown in FIGS. 2A and 6A, the display device 239a in the projection device 200a is adapted to perform an angular rotation such as 90° so that the projected image is changed from a M×N resolution to an N×M resolution, wherein M>N. When the display device 239a has a resolution of 800×600 (800 columns×600 rows), the control unit 260a will control the imaging unit 230a and the image displacement element 240 to project the sub-images sequentially onto various sub-regional blocks including, for example, a first sub-regional block 312a, a second sub-regional block 314a, a third sub-regional block 316 and a fourth sub-regional block 318 on the screen 300 each having a resolution of 800×600. Furthermore, these sub-regional blocks 312a, 314a, 316 and 318 each with a resolution of 800×600 are synchronized to form a single block 310 with a resolution of 1 024×768. Although there is some overlapping between these sub-regional blocks 312a, 314a, 316 and 318, the overlaps belong to the same image.

As shown in FIGS. 2A and 6B, the display device 239a in the present embodiment rotates an angle such as 90° so that the resolution of the projected image is 600×800 (600 column×800 row). The control unit 260a will control the imaging unit 230a and the image displacement element 240 to project the sub-images sequentially onto various sub-regional blocks including, for example, a fifth sub-regional block 312b and a sixth sub-regional block 314b on the screen 300 each having a resolution of 600×768. Furthermore, these sub-regional blocks 312b and 314b each with a resolution of 600×768 are synchronized to form a single block 310 with a resolution of 1 024×768. Although there is some overlapping between these sub-regional blocks 312b and 314b, the overlaps belong to the same image. Thus, after rotating the display device 239a by a definite angle, just two sub-regional blocks 312b and 314b can be synchronized to produce a regional block 310 having a 1 024×768 resolution.

It should be noted that the block 310 in FIG. 6B has a 1 024×768 resolution. Although the display device 239a projects a 600×800 resolution sub-regional block, the control unit 260a will control the remaining 32 rows not to display any image. Therefore, the fifth sub-regional block 316b and the sixth sub-regional block 314b on the screen 300 have a 600×768 resolution.

FIG. 2B is a schematic diagram showing various components of an alternative image projection device according to the first embodiment of the present invention. As shown in FIGS. 2A and 2B, the image displacement element 240 of the image projection device 200a can be positioned between the imaging unit 240 and the projection lens 220a (as shown in FIG. 2A) or directly positioned inside the projection lens 220b (as shown in FIG. 2B). In this case, when the beam of white light 212 is split into a plurality of sub-images by the imaging unit 230a, the sub-images will be directly transmitted to the projection lens 220b. However, the sub-images will pass through the optical path compensator 250 before going to the projection lens 220b. As shown in FIG. 5, the projection lens 220b not only projects the sub-images on the screen 300, but the image displacement element 240 inside the projection lens 220b also switch the imaging positions of the sub-images. Therefore, the sub-images not shifted by the image displacement element 240 are projected onto areas such as the first sub-regional block 312a of the screen 300. Meanwhile, the sub-images shifted by the image displacement element 240 are projected onto other areas such as the second sub-regional block 314a of the screen 300. In addition, the transmission path of the white light 212, the action of the optical path compensator 250 and the method of integrating all the sub-images to form an image on the screen 300 are very similar to the aforementioned embodiment. Hence, detailed description is omitted.

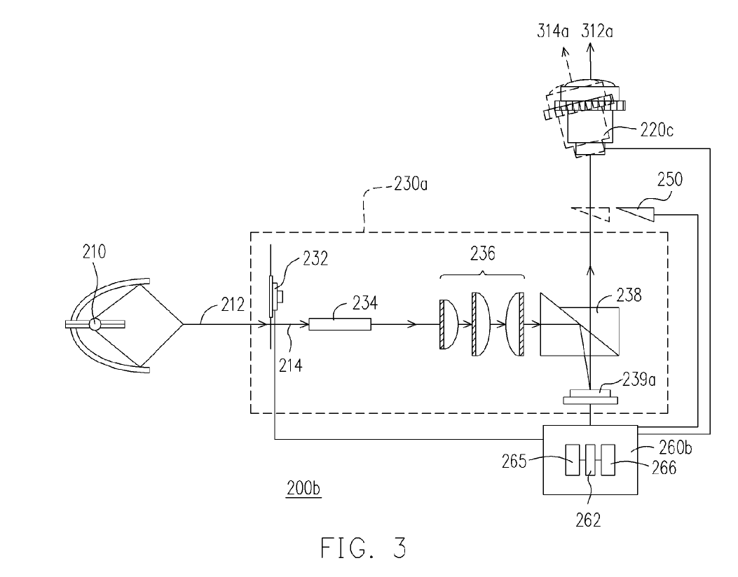

FIG. 3 is a schematic diagram showing various components of an image projection device according to a second embodiment of the present invention. As shown in FIG. 3, another image projection device 200b is provided in a second embodiment of the present invention. The image projection device 200b mainly comprises a light source 210, a moveable projection lens 220c, an imaging unit 230a, an optical path compensator 250 and a control unit 260b. The light source 210 provides a beam of white light 212 and the moveable projection lens 220c is disposed somewhere along the path of the light beam 212. The imaging unit 230a is disposed between the light source 210 and the moveable projection lens 220c. The imaging unit 230a is designed to convert the beam of white light 212 into a plurality of sub-images within each frame. The imaging unit 230a can be a liquid crystal display (LCD) imaging unit, a digital light processing (DLP) imaging unit or a reflective liquid crystal on silicon (LCOS) display unit, for example. Using a digital light processing (DLP) imaging unit as an example, the imaging unit 230a comprises a color wheel 232, a light integration rod 234, a condenser 236, a total internal reflection (TIR) prism 238 and a display device 239a. The control unit 260b is, for example, a circuit board comprising an image processor 262, a moveable projection lens controller 266 and an optical path compensator controller 265. In the present embodiment, the control unit 260b is electrically connected to the color wheel 232 and the display unit 239a for controlling the production of images.

In the aforementioned projection device 200b, the white beam 212 from the light source 210 passes through the color wheel 232 controlled by the control unit 260b. The color wheel 232 comprises a combination of color filters for red, green and blue light, for example. Through the red, green and blue color filters in the color wheel 232, the white light 212 is split in sequence into red, green and blue monochromatic light beams 214. These monochromatic light beams 214 sequentially pass through the light integration rod 234 and the condenser 236 before entering the TIR prism 238. The TIR prism 238 reflects the sequentially input monochromatic light beams 214 to the display device 239a. Thereafter, the image processor 262 inside the control unit 260b controls the display device 239a to convert the monochromatic light beams 214 into monochromatic images (not shown) in sequence.

After converting the monochromatic light beams 214 into a plurality of sub-images through the display device 239a, light from the sub-images are passed back to the TIR prism 238 again. The sub-images not shifted by the moveable projection lens 220c are directly transmitted to the moveable projection lens 220c. Meanwhile, the sub-images shifted by the moveable projection lens 220c have to pass through the optical path compensator 250 before moving on to the moveable projection lens 220c. The optical path compensator 250 has a wedge shape, for example. The optical path compensator 250 is designed to interpose into the transmission path of the sub-images at a prescribed time interval so that any optical path difference is improved. In the present embodiment, the optical path compensator 250 may interpose into an area between the imaging unit 230a and the moveable projection lens 220c during a prescribed time interval or interpose into the interior of the moveable projection lens 220c during a prescribed time interval. In addition, the optical path compensator controller 265 controls the movement of the optical path compensator 250 so that any optical path difference in the sub-images is improved. The optical path compensator controller 265 is electrically connected to the image processor 262 of the control unit 260b.

Thereafter, the sub-images pass through the moveable projection lens 220c. The moveable projection lens controller 266 having an electrical connection with the image processor 262 controls the moveable projection lens 220 to switch the imaging positions of the sub-images and display the sub-images on the screen 300. As shown in FIG. 5, the sub-images not shifted by the moveable projection lens 220c are projected onto an area such as the first sub-regional block 312a of the screen 300. Meanwhile, the sub-images shifted by the moveable projection lens 220c are projected onto another area such as the second sub-regional block 314a of the screen 300. In addition, under the control of the control unit 260b, the imaging unit 230a and the moveable projection lens 220c synchronize the sub-images to form an image having a resolution higher than each sub-image. It should be noted that the moveable projection lens 220c could shift the position of these sub-images by a distance in excess of several tens of pixels. Because the action of the optical path compensator 250 and the method of projecting sub-images on the screen 300 to form an image are similar to the aforementioned embodiment, a detailed description is omitted.

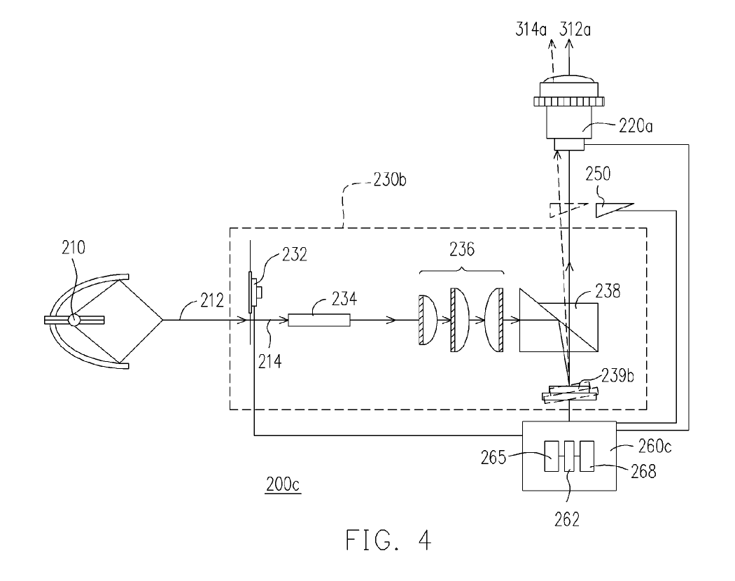

FIG. 4 is a schematic diagram showing various components of an image projection device according to a third embodiment of the present invention. As shown in FIG. 4, another image projection device 200c is provided in a third embodiment of the present invention. The image projection device 200c mainly comprises a light source 210, a projection lens 220a, an imaging unit 230b, an optical path compensator 250 and a control unit 260c. The light source 210 provides a beam of white light 212 and the projection lens 220a is disposed somewhere along the path of the light beam 212. The imaging unit 230b is disposed between the light source 210 and the projection lens 220a. The imaging unit 230b is designed to convert the beam of white light 212 into a plurality of sub-images within each frame. The imaging unit 230b can be a liquid crystal display (LCD) imaging unit, a digital light processing (DLP) imaging unit or a reflective liquid crystal on silicon (LCOS) display unit, for example. Using a digital light processing (DLP) imaging unit as an example, the imaging unit 230b comprises a color wheel 232, a light integration rod 234, a condenser 236, a total internal reflection (TIR) prism 238 and a moveable display device 239b. The control unit 260c is, for example, a circuit board comprising an image processor 262, a moveable display device controller 268 and an optical path compensator controller 265. In the present embodiment, the control unit 260c is electrically connected to the color wheel 232 and the moveable display unit 239b for controlling the production of images.

In the aforementioned projection device 200c, the white beam 212 from the light source 210 passes through the color wheel 232 controlled by the control unit 260c. The color wheel 232 comprises a combination of color filters for red, green and blue light, for example. Through the red, green and blue color filters in the color wheel 232, the white light 212 is split in sequence into red, green and blue monochromatic light beams 214. These monochromatic light beams 214 sequentially pass through the light integration rod 234 and the condenser 236 before entering the TIR prism 238. The TIR prism 238 reflects the sequentially input monochromatic light beams 214 to the moveable display device 239b.

The image processor 262 inside the control unit 260c controls the moveable display device 239b to convert the monochromatic light beams 214 into a plurality of sub-images (not shown). In addition, under the control of the image processor 262 inside the control unit 260c, the moveable display device controller 266 having electrical connection with the image processor 262 directs the movement of the moveable display device 239b to switch the imaging positions of the sub-images. As shown in FIG. 5, the sub-images not shifted by the moveable display device 239b are projected onto an area such as the first sub-regional block 312a of the screen 300. Meanwhile, the sub-images shifted by the moveable display device 239b are projected onto another area such as the second sub-regional block 314a of the screen 300.

After converting the monochromatic light beams 214 into a plurality of sub-images through the moveable display device 239b, light from the sub-images are passed back to the TIR prism 238 again. The sub-images not shifted by the moveable display device 239b are directly transmitted to the projection lens 220a. Meanwhile, the sub-images shifted by the moveable display device 239b have to pass through the optical path compensator 250 before moving on to the projection lens 220a. The optical path compensator 250 has a wedge shape, for example. The optical path compensator 250 is designed to interpose into the transmission path of the sub-images at a prescribed time interval so that any optical path difference is improved. In the present embodiment, the optical path compensator 250 may interpose into an area between the imaging unit 230b and the projection lens 220a during a prescribed time interval or interpose into the interior of the projection lens 220a during a prescribed time interval. In addition, the optical path compensator controller 265 controls the movement of the optical path compensator 250 so that any optical path difference in the sub-images is improved. The optical path compensator controller 265 is electrically connected to the image processor 262 of the control unit 260b. It should be noted that the moveable display device 239b could shift the position of these sub-images by a distance in excess of several tens of pixels.

Thereafter, the sub-images are projected onto the screen 300 through the projection lens 220a. Under the control of the control unit 260c, the imaging unit 230b synchronizes the sub-images to form an image on the screen having a resolution higher than each sub-image. Because the action of the optical path compensator 250 and the method of projecting sub-images on the screen 300 to form an image are similar to the aforementioned embodiments, a detailed description is omitted.

In summary, the image projection device of the present invention deploys a control unit to synchronize the conversion of the light beam into a plurality of sub-images within each frame by the imaging unit. In addition, an image displacement element, a moveable projection lens or a moveable display device is used to switch the imaging positions of these sub-images and synchronize these sub-images to form an image. Therefore, the image projection device can use a low-resolution display device to form a high-resolution image. Because a high-resolution display device cost more than a low-resolution display device, the production cost of the image projection device of the present invention is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image projection device, comprising:
a light source for providing a light beam;
a projection lens disposed along the transmission path of the light beam;
an imaging unit disposed between the light source and the projection lens, wherein the imaging unit converts the light beam into a plurality of sub-images within each frame;
an image displacement element disposed along the transmission path of the sub-images, wherein the image displacement element switches the imaging positions of the sub-images after passing through the projection lens;
an optical path compensator for interposing into the transmission path of the sub-images within a prescribed time interval for compensating the optical path difference; and
a control unit for controlling the imaging unit and the image displacement element so that the sub-images are synchronized to form an image having a higher resolution than each sub-image.

2. The image projection device of claim 1, wherein the imaging device comprises a liquid crystal display imaging unit, a digital light processing imaging unit or a liquid crystal on silicon imaging unit.

3. The image projection device of claim 1, wherein the imaging unit further comprises a display device capable of rotating an angle so that the projected image through the display device changes from a M×N resolution to a N×M resolution, where M>N.

4. The image projection device of claim 1, wherein the imaging unit comprises a transparent plate or a reflective plate.

5. The image projection device of claim 1, wherein the image displacement element is disposed between the imaging unit and the projection lens.

6. The image projection device of claim 1, wherein the image displacement element is disposed inside the projection lens.

7. The image projection device of claim 1, wherein the optical path compensator is suitable for interposing into an area between the imaging unit and the projection lens within a prescribed time interval.

8. The image projection device of claim 1, wherein the optical path compensator is suitable for interposing into the interior of the projection lens within a prescribed time interval.

9. The image projection device of claim 1, wherein the optical path compensator has a rectangular shape.

10. The image projection device of claim 1, wherein the control unit further comprises:
an image processor for controlling the sub-images displayed by the imaging unit;
an image displacement element controller electrically connected to the image processor for controlling the movement of the image displacement element; and
an optical path compensator controller electrically connected to the image processor for controlling the movement of the optical path compensator.

11. An image projection device, comprising:
a light source for providing a light beam;
a moveable projection lens disposed along the transmission path of the light beam;
an imaging unit disposed between the light source and the moveable projection lens, wherein the imaging unit converts the light beam into a plurality of sub-images within each frame, and the moveable projection lens switches the imaging positions of the sub-images;
an optical path compensator for interposing into the transmission path of the sub-images within a prescribed time interval for compensating the optical path difference; and
a control unit for controlling the imaging unit and the moveable projection device so that the sub-images are synchronized to form an image having a higher resolution than each sub-image.

12. The image projection device of claim 11, wherein the imaging device comprises a liquid crystal display imaging unit, a digital light processing imaging unit or a liquid crystal on silicon imaging unit.

13. The image projection device of claim 11, wherein the imaging unit further comprises a display device capable of rotating an angle so that the projected image through the display device changes from a M×N resolution to a N×M resolution, where M>N.

14. The image projection device of claim 11, wherein the optical path compensator is suitable for interposing into an area between the imaging unit and the moveable projection lens within a prescribed time interval.

15. The image projection device of claim 11, wherein the optical path compensator is suitable for interposing into the interior of the moveable projection lens within a prescribed time interval.

16. The image projection device of claim 11, wherein the optical path compensator has a wedge shape.

17. The image projection device of claim 11, wherein the control unit further comprises:
an image processor for controlling the sub-images displayed by the imaging unit;
a moveable projection lens controller electrically connected to the image processor for controlling the movement of the moveable projection lens; and
an optical path compensator controller electrically connected to the image processor for controlling the movement of the optical path compensator.

18. An image projection device, comprising:
a light source for providing a light beam;
a projection lens disposed along the transmission path of the light beam;
an imaging unit disposed between the light source and the moveable projection lens, wherein the imaging unit has a moveable display device for converting the light beam into a plurality of sub-images within each frame and switching the imaging positions of the sub-images;
an optical path compensator for interposing into the transmission path of the sub-images within a prescribed time interval for compensating the optical path difference; and
a control unit for controlling the imaging unit so that the sub-images are synchronized to form an image having a higher resolution than each sub-image.

19. The image projection device of claim 18, wherein the imaging device comprises a liquid crystal display imaging unit, a digital light processing imaging unit or a liquid crystal on silicon imaging unit.

20. The image projection device of claim 18, wherein the imaging unit further comprises a display device capable of rotating an angle so that the projected image through the display device changes from a M×N resolution to a N×M resolution, where M>N.

21. The image projection device of claim 18, wherein the optical path compensator is suitable for interposing into an area between the moveable display device and the projection lens within a prescribed time interval.

22. The image projection device of claim 18, wherein the optical path compensator is suitable for interposing into the interior of the projection lens within a prescribed time interval.

23. The image projection device of claim 18, wherein the optical path compensator has a wedge shape.

24. The image projection device of claim 18, wherein the control unit further comprises:
an image processor for controlling the sub-images displayed by the moveable display device;
a moveable display device controller electrically connected to the image processor for controlling the movement of the moveable display device; and
an optical path compensator controller electrically connected to the image processor for controlling the movement of the optical path compensator.
